(19) United States
(12) Patent Application Publication
(10) Pub. No.: US 2025/0135888 A1
(43) Pub. Date: May 1, 2025

(54) COMPUTER-IMPLEMENTED METHOD FOR CONTROLLING A GRAPHICAL USER INTERFACE ON A DISPLAY OF A VEHICLE

(71) Applicant: Continental Automotive Technologies GmbH, Hannover (DE)

(72) Inventors: Stephan Cieler, Frankfurt (DE); Markus Bosl, Offenbach (DE); Heidi von Bychowski, Bad Homburg (DE); Bettina Leuchtenberg, Ehringshausen (DE); Sebastian Weiss, Aschaffenburg (DE)

(73) Assignee: Continental Automotive Technologies GmbH, Hannover (DE)

(21) Appl. No.: 18/925,612

(22) Filed: Oct. 24, 2024

(30) Foreign Application Priority Data
Oct. 25, 2023 (DE) 10 2023 210 557.8

(51) Int. Cl. B60K 35/81; B60K 35/28; B60W 50/14

(52) U.S. Cl. CPC B60K 35/81; B60K 35/28; B60W 50/14; B60K 2360/11; B60K 2360/176; B60K 2360/182; B60K 2360/1868; B60K 2360/1876; B60K 2360/188; B60K 2360/779; B60W 2050/146

(57) ABSTRACT

A computer-implemented method for controlling a graphical user interface on a display of a vehicle is disclosed. The method comprises receiving a current driving mode, wherein, if the current driving mode corresponds to high or full automation, the method comprises receiving driver-side image data, comprising an image of a driver-side rear field of view; receiving passenger-side image data, comprising an image of a passenger-side rear field of view; displaying the driver-side and passenger-side image data in the driver-side digital rearview mirror area such that said data are displayed less obviously than in a manual driving mode; identifying objects in the driver-side and the passenger-side image data; checking whether at least one trigger object has been identified in the objects, wherein, if at least one trigger object has been identified, adapting the graphical user interface, and displaying the adapted graphical user interface on the display of the vehicle.

### CROSS REFERENCE TO RELATED APPLICATION

This US patent application claims the benefit of German patent application No. 10 2023 210 557.8, filed Oct. 25, 2023, which is hereby incorporated by reference.

### TECHNICAL FIELD

The present disclosure relates to the field of graphical user interfaces. In particular, the present disclosure relates to a computer-implemented method for controlling a graphical user interface on a display of a vehicle and, accordingly, to a computer program product, to a computer-readable storage medium, to a data carrier signal, to a data processing device and to a vehicle.

### BACKGROUND

The Society of Automotive Engineers (SAE) International has defined a progressive measure for automating a driving mode of vehicles in the form of the SAE J3016 standard. The associated levels are: level 0 (no automation); level 1 (assistance systems); level 2 (semiautomation); level 3 (conditional automation); level 4 (high automation); and level 5 (full automation).

In a high (level 4) or fully automated (level 5) vehicle, the driver no longer needs to intervene in the driving process. The environment and events occurring therein no longer need to be observed by the driver. This eliminates the need to display some information inside the vehicle, which can even be perceived as disturbing to the driver. Nevertheless, such content is still displayed in the interior of the vehicle, for example on a graphical user interface on a display, regardless of the driving mode.

In order to improve the understanding and acceptance of the driver with regard to automated driving, it is therefore desirable not to display unnecessary information at all or in a manner that is less disruptive to the driver as soon as the vehicle travels in a partially automated or fully automated manner. This enables the driver to perform non-driving tasks and increases awareness of the current driving mode of the vehicle.

### SUMMARY

It is therefore the object of the disclosure to provide a method for the improved display of a graphical user interface on a display of a vehicle that takes account of the current driving mode.

This is achieved according to the disclosure by way of a computer-implemented method and a computer program product, a computer-readable storage medium, a data carrier signal, a data processing device and a vehicle according to the respective main claims. Configurations may be taken from the subclaims.

According to a first aspect of the disclosure, a computer-implemented method for controlling a graphical user interface on a display of a vehicle comprises a reception step in which a current driving mode is received. The driving mode characterizes the degree of automated driving of the vehicle. Said driving mode may be provided, for example, by a central computing unit of the vehicle in which the current driving mode is known or by any other components in the vehicle that have knowledge of the current driving mode and may pass it on.

The current driving mode is characterized by a classification according to SAE J3016. This standard describes the classification and definition of the degree of automation of road-bound motor vehicles in 6 levels. The first 3 levels 0-2 correspond to a low degree of automation in which the driver monitors the driving area. The three highest levels 3-5 characterize a degree of automation in which a system monitors the driving area; in particular, level 4 describes high automation and level 5 describes full automation.

According to the first aspect of the disclosure, the user interface of the display of the vehicle comprises at least one driver-side digital rearview mirror area and at least one passenger-side digital rearview mirror area. The display may in this case be in the form of a single module, for example an LCD display. However, it is also possible that the display consists of multiple screens. The driver-side digital rearview mirror area is typically located in the interior near the driver-side rearview mirror. Similarly, the passenger-side digital rearview mirror area is typically located in the interior of the vehicle near the passenger-side rearview mirror.

The graphical user interface comprises at least one additional display area. In other words, the display of the vehicle does not only consist of a driver-side digital rearview mirror area and a passenger-side digital rearview mirror area, so that other information, for example navigation elements, music control elements or temperature control elements, can be displayed on the display in the vehicle.

According to the first aspect of the disclosure, the method comprises further steps if the current driving mode corresponds to high or full automation. If this is the case, driver-side image data comprising an image of a driver-side rear field of view are received. In addition, passenger-side image data comprising an image of a passenger-side rear field of view are received. For this purpose, for example, it is possible to use cameras that are mounted in place of a conventional rearview mirror and are aligned in the opposite direction to the direction of forward travel of the vehicle. Furthermore, the driver-side image data are displayed in the driver-side digital rearview mirror area and the passenger-side image data are displayed in the passenger-side digital rearview mirror area in such a way that said data are displayed less obviously than in a manual driving mode with low automation.

In a further step of the computer-implemented method according to the first aspect of the disclosure, objects are identified in the driver-side image data and the passenger-side image data. This may be done by a conventional object identification process. Known objects may include people, cyclists, other vehicles, ambulances, police vehicles or fire trucks, for example.

In a further step, a check is carried out to determine whether at least one trigger object can be identified in the objects. A trigger object is in this case a previously defined object of particular importance. This could be an ambulance, a police vehicle or a fire truck, for example. Such objects are typically defined as trigger objects, which are intended to attract the driver's attention despite the high or full automated driving mode of the vehicle. This increases the driver's acceptance of automated driving because they are kept informed of important objects and events in their environment.

If at least one trigger object is identified, the method comprises a step in which the graphical user interface is adapted. In particular, the driver-side digital rearview mirror area and the passenger-side digital rearview mirror area are modified in such a way that they become more prominent and thus attract the driver's attention.

The trigger object corresponds to an ambulance, a fire truck, a police vehicle, a bicycle or a person. These are typically objects whose presence in the vicinity of the vehicle requires increased driver attention.

The adaptation of the graphical user interface is achieved by a change in size, a change in color, a change in contrast and/or a change in blurring of the driver-side image data and/or the passenger-side image data.

If the vehicle is manually controlled by the driver, the driver-side and passenger-side image data are displayed concisely and clearly visibly in the driver-side digital rearview mirror area and passenger-side rearview mirror area, respectively, as their content is relevant to the driver in manual driving mode. If the vehicle changes driving mode to one characterized by high or even full automation, the display of the digital rearview mirror areas may be presented less concisely, for example by way of a change in contrast, so that the driver's attention is not unnecessarily directed to this part of the display.

In a further step of the computer-implemented method according to the first aspect of the disclosure, the graphical user interface is displayed on the display of the vehicle.

According to a second aspect of the disclosure, a computer program product contains instructions that, when the program is executed by a computer, cause said computer to carry out the method as claimed in one of the preceding claims. The computer program product may be executed completely on the vehicle. However, it may also be executed partly on the vehicle and partly outside the vehicle, for example on a server. For example, all of the method steps except for object identification and the checking of trigger objects may be executed inside the vehicle, with the remaining steps being executed on a server.

According to a third aspect of the disclosure, a computer-readable storage medium contains instructions that, when executed by a computer, cause said computer to carry out one of the previously described methods.

According to a fourth aspect of the disclosure, a data carrier signal transmits the previously described computer program product.

According to a fifth aspect of the disclosure, a data processing device comprises a processor that is configured such that it is able to carry out the steps of one of the previously described computer-implemented methods. Furthermore, the data processing device comprises a previously described computer-readable storage medium that is communicatively connected to the processor. In addition, the data processing device comprises a driver-side rearview mirror camera, a passenger-side rearview mirror camera, and a display that are communicatively connected to the processor.

According to a sixth aspect of the disclosure, a vehicle comprises a previously described data processing device.

### BRIEF DESCRIPTION OF THE FIGURES

The disclosure is described in greater detail below on the basis of exemplary embodiments with the aid of Figures. In the Figures:

FIG. 1: shows a flowchart of the computer-implemented method for controlling a graphical user interface on a display of a vehicle;

FIG. 2: shows a display for the computer-implemented method from FIG. 1;

FIG. 3: shows a first view of the vehicle for the computer-implemented method from FIG. 1;

FIG. 4: shows a second view of the vehicle for the computer-implemented method from FIG. 1; and

FIG. 5: shows a data processing device that can execute the computer-implemented method from FIG. 1.

### DETAILED DESCRIPTION

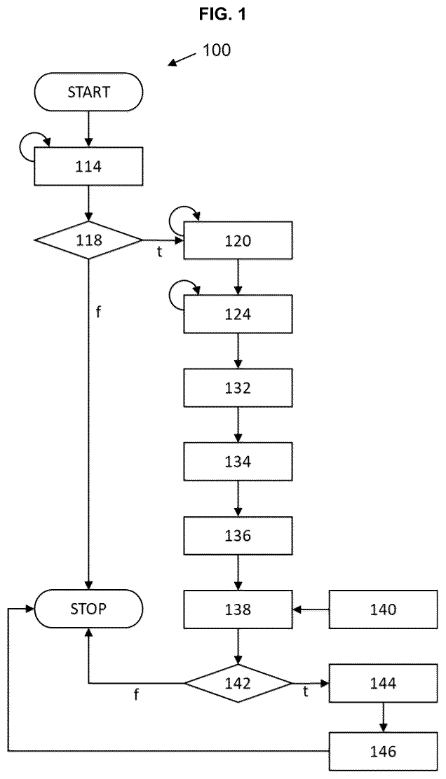

FIG. 1 shows a flowchart of a computer-implemented method 100 for controlling a graphical user interface 102 on a display 104 of a vehicle 106.

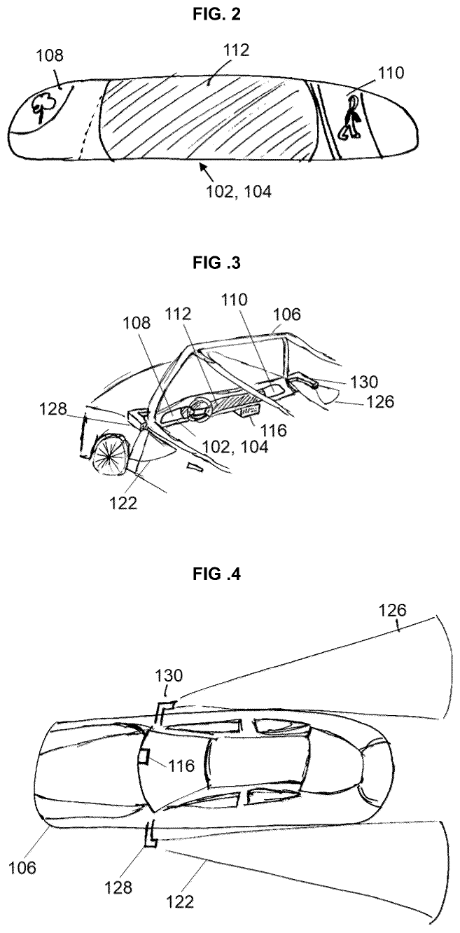

Before the individual steps of the computer-implemented method 100 are explained, an example for the display 104 may be considered with the aid of FIG. 2.

FIG. 2 shows a display 104 for the computer-implemented method 100 from FIG. 1.

The display 104 shows a graphical user interface 102, for example by means of a liquid crystal display (LCD). The graphical user interface 102 consists of a driver-side digital rearview mirror area 108 and a passenger-side digital rearview mirror area 110. Furthermore, the graphical user interface 102 comprises an additional display area 112, on which information such as speed, tank level, battery level, audio control elements or temperature control elements may be displayed. Parts of or the entire display 104 may also be in the form of a touch screen, so that it is possible to interact with the display 104.

With reference to FIG. 1, the computer-implemented method 100 comprises a first reception step 114, in which a current driving mode is received. The current driving mode characterizes the degree of automation of the vehicle 106. This classification is usually defined according to the SAE J3016 standard, where a high level of automation is denoted by Level 4 and a full level of automation is denoted by Level 5. The current driving mode can be received, for example, from a control module 116, which is shown in FIG. 3.

FIG. 3 shows a first view of the vehicle 106 for the computer-implemented method 100 from FIG. 1. The control module 116 may be designed to carry out the computer-implemented method 100. To this end, it may be part of another component, for example an infotainment system. However, it is also possible that the control module 116 is a separate component in the vehicle 106. The control module 116 may carry out some or all of the steps of the computer-implemented method 100. It is possible that the control module 116 also takes on other functions of the vehicle 106, for example the control of an infotainment system.

Referring again to FIG. 1, the computer-implemented method 100 comprises a decision step 118 in which a check is carried out to determine whether the current driving mode corresponds to high or full automation. If this is true (see t-branch in FIG. 1), a second reception step 120 is executed. In this step, driver-side image data comprising an image of a driver-side rear field of view 122 are received.

In a further step of the computer-implemented method 100, in the third reception step 124, passenger-side image data comprising an image of a passenger-side rear field of view 126 are received.

FIGS. 3 and 4 show the vehicle 106 as well as the rear fields of view 122, 126. In the example of FIG. 3 and FIG. 4, the driver-side image data are recorded by a driver-side rearview mirror camera 128. Similarly, the passenger-side image data are recorded by a passenger-side rearview mirror camera 130. The driver-side rearview mirror camera 128 is configured so that it is arranged on the driver-side part of the vehicle 106 and may record driver-side image data that cover the driver-side rear field of view 122. The same applies to the passenger-side rearview mirror camera 130, which is configured so that it is arranged on the passenger-side part of the vehicle 106 and can record passenger-side image data that cover the passenger-side rear field of view 126.

Referring again to FIG. 1, the computer-implemented method 100 comprises a first display step 132 in which the driver-side image data are displayed in the driver-side digital rearview mirror area 108 in such a way that they stand out less obviously than in a manual driving mode. In a second display step 134, the passenger-side image data are displayed analogously thereto in the passenger-side digital rearview mirror area 110. These data, too, have been adapted in terms of their appearance in such a way that they stand out less obviously in comparison to their display in a manual driving mode. For example, in order to achieve such a less obvious appearance, the image data may be adjusted in size, contrast, or color range, or may be displayed in grayscale only, and/or in a slightly smudged manner by blurring.

In an identification step 136 of the computer-implemented method 100, objects are identified in the driver-side image data and the passenger-side image data. Since the image data are images of a rear field of view 122, 126, typical identifiable objects are, for example, people, other vehicles, vegetation, road signs or road lanes. In the example of FIG. 2, for example, a person, a sidewalk, a tree and a roadway with lane strips are contained in the image data and are thus depicted on the digital rearview mirror areas 108, 110.

In a checking step 138, a check is carried out to determine whether at least one trigger object 140 has been identified in the objects. Trigger objects 140 are particularly those objects whose presence in the vicinity of the vehicle 106 requires increased driver attention. Typical trigger objects 140 are, for example, police vehicles, fire trucks or ambulances.

A control step 142 checks whether at least one trigger object 140 has been identified in the objects. If this is the case (t-branch in FIG. 1), an adaptation step 144 is carried out in which the graphical user interface 102 and in particular the driver-side digital rearview mirror area 108 and the passenger-side digital rearview mirror area 110 are changed in terms of their display. Until a trigger object 140 is identified, the digital rearview mirror areas 108, 110 are displayed less obviously. It may even be possible to highlight the additional display area 112, for example by way of a colored border. If the driver looks at the display 104, their attention is thus directed to the additional display area 112.

With the identification of a trigger object 140 in the image data, the digital rearview mirror areas 108, 110 are displayed differently, for example again significantly more concisely. This may be done, for example, by readjusting the image size, contrast, or blur. It is also possible to graphically highlight the identified trigger objects 140, for example by way of a color-highlighted frame around them. These measures draw the driver's attention to the digital rearview mirror areas 108, 110 and increase their understanding of the current traffic situation. These measures may also help to inform the driver of the next steps that the automated vehicle 106 will take in such a situation. This increases the driver's acceptance of the automated driving mode.

In a final step of the computer-implemented method 100, the display step 146, the graphical user interface 102 is displayed on the display 104 of the vehicle. The information is thus visible to the driver of the vehicle 106.

By way of the computer-implemented method 100 in FIG. 1, the driver of the vehicle 106 is on the one hand informed that their environment is no longer of interest. On the other hand, in those situations, the driver is informed of what is happening around them, even when driving in automated mode. This builds situational awareness.

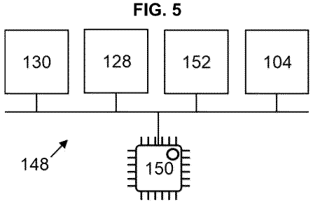

FIG. 5 shows a data processing device 148 that comprises a processor 150 that is configured in such a way that it may carry out the computer-implemented method 100 from FIG. 1. Furthermore, the data processing device 148 comprises a computer-readable storage medium 152 and a driver-side rearview mirror camera 128 and a passenger-side rearview mirror camera 130 that are communicatively connected to the processor 150. Finally, the data processing device 148 comprises a display 104 that is also communicatively connected to the processor 150.

In the example of FIG. 4, the vehicle 106 comprises all the elements of a data processing device 148, wherein the processor 150 and the computer-readable storage medium 152 are part of the control module 116.

1. A computer-implemented method for controlling a graphical user interface on a display of a vehicle, wherein the graphical user interface comprises at least one driver-side digital rearview mirror area and at least one passenger-side digital rearview mirror area, the method comprising:
receiving a current driving mode,
wherein, if the current driving mode corresponds to high or full automation, the method comprises:
receiving driver-side image data, comprising an image of a driver-side rear field of view,
receiving passenger-side image data, comprising an image of a passenger-side rear field of view,
displaying the driver-side image data in the driver-side digital rearview mirror area in such a way that said data are displayed less obviously than in a manual driving mode,
displaying the passenger-side image data in the passenger-side digital rearview mirror area in such a way that said data are displayed less obviously than in the manual driving mode,
identifying objects in the driver-side image data and the passenger-side image data,
checking whether at least one trigger object has been identified in the objects,
wherein, if at least one trigger object has been identified, the method comprises:
adapting the graphical user interface, in particular the driver-side digital rearview mirror area and the passenger-side digital rearview mirror area, and
displaying the adapted graphical user interface on the display of the vehicle.

2. The computer-implemented method as claimed in claim 1, wherein the current driving mode is characterized by a classification according to SAE J3016.

3. The computer-implemented method as claimed in claim 1, wherein the graphical user interface comprises at least one additional display area.

4. The computer-implemented method as claimed in claim 1, wherein the at least one trigger object corresponds to at least one of an ambulance, a fire truck, a police vehicle, a bicycle and a person.

5. The computer-implemented method as claimed in claim 1, wherein the adaptation of the graphical user interface is achieved by at least one of a change in size, a change in color, a change in contrast, a change in blurring of the driver-side image data, and the passenger-side image data.

6. A computer program product containing instructions that, when the program is executed by a computer, cause said computer to carry out the method as claimed in claim 1.

7. A computer-readable storage medium containing instructions that, when executed by a computer, cause the computer to perform operations comprising:
receiving a current driving mode,
wherein, if the current driving mode corresponds to high or full automation, the method comprises:
receiving driver-side image data, comprising an image of a driver-side rear field of view,
receiving passenger-side image data, comprising an image of a passenger-side rear field of view,
displaying the driver-side image data in the driver-side digital rearview mirror area in such a way that said data are displayed less obviously than in a manual driving mode,
displaying the passenger-side image data in the passenger-side digital rearview mirror area in such a way that said data are displayed less obviously than in the manual driving mode,
identifying objects in the driver-side image data and the passenger-side image data,
checking whether at least one trigger object has been identified in the objects,
wherein, if at least one trigger object has been identified:
adapting the graphical user interface, in particular the driver-side digital rearview mirror area and the passenger-side digital rearview mirror area, and
displaying the adapted graphical user interface on the display of the vehicle.

8. A data processing device, comprising:
a processor that is configured such that it is able to carry out the steps of the computer-implemented method,
a computer-readable storage medium that is communicatively connected to the processor,
a driver-side rearview mirror camera that is communicatively connected to the processor,
a passenger-side rearview mirror camera that is communicatively connected to the processor, and
a display that is communicatively connected to the processor.

9. The data processing device as claimed in claim 8, wherein the data processing device is located in a vehicle.
